(19) United States
(12) Patent Application Publication
(10) Pub. No.: US 2021/0125468 A1
(43) Pub. Date: Apr. 29, 2021

(54) NOTIFICATION DELIVERY FOR WORKERS WEARING PERSONAL PROTECTIVE EQUIPMENT

(71) Applicant: 3M INNOVATIVE PROPERTIES COMPANY, St. Paul, MN (US)

(72) Inventors: Vera Shuman, St. Paul, MN (US); John M. Kruse, Minneapolis, MN (US); Lori A. Sjolund, Stillwater, MN (US)

(21) Appl. No.: 17/250,231

(22) PCT Filed: Jun. 26, 2019
(86) PCT No.: PCT/IB2019/055423

§ 371 Date: Dec. 21, 2020

Related U.S. Application Data
(60) Provisional application No. 62/691,358, filed on Jun. 28, 2018.

(51) Int. Cl. G08B 1/04; A62B 99/00; A62B 9/00; A62B 18/08

(52) U.S. Cl. CPC G08B 1/04; A62B 18/08; A62B 9/006; A62B 99/00

(57) ABSTRACT

Systems and methods for delivering notifications to users in a work environment are provided. A fluid notification device is provided to attach to a wearable article of personal protection equipment (PPE) to be worn by the user. The fluid notification device includes a fluid source component and a fluid flow channel being configured to direct a fluid flow (e.g., a gas flow or a scent) from the fluid source component to the user to deliver perceptible messages. An electronic control unit is functionally connected to the fluid source component to control the delivery of the perceptible message, the control being independent from the operation of the article of PPE.

### TECHNICAL FIELD

The present disclosure relates to systems and methods for delivering notifications to workers wearing personal protective equipment.

### BACKGROUND

When working in areas where there is known to be, or there is a potential of there being, dusts, fumes, gases, airborne contaminants, fall hazards, hearing hazards or any other hazards that are potentially hazardous or harmful to health, it is usual for a worker to use personal protective equipment (PPE), such as respirator or a clean air supply source. While a large variety of personal protective equipment are available, some commonly used devices include powered air purifying respirators (PAPR), self-contained breathing apparatuses, fall protection harnesses, ear muffs, face shields, and welding masks. For instance, a PAPR typically includes a blower system comprising a fan powered by an electric motor for delivering a forced flow of air through a tube to a headpiece worn by a user. A PAPR typically includes a device that draws ambient air through a filter, forces the air through a breathing tube and into a helmet or headpiece to provide filtered air to a user's breathing zone, around their nose or mouth. A self-contained breathing apparatus (SCBA) provides clean air from a compressed air tank through a tube or hose to the interior of a headpiece worn by a user. In some examples, various personal protective equipment may generate various types of data.

### SUMMARY

There is a desire to effectively deliver notifications to workers wearing personal protective equipment (PPE) in a work environment. The present disclosure provides systems and methods for providing notifications to the workers by delivering perceptible messages via a fluid flow (e.g., a gas flow or a scent).

In one aspect, the present disclosure describes a notification system including at least one wearable article of personal protection equipment (PPE) to be worn by a user, and a fluid notification device attached to the wearable article of PPE. The fluid notification device includes a fluid source component to release a fluid flow and a fluid flow channel being configured to direct the fluid flow from the fluid source component to the user to deliver perceptible messages. The fluid notification device further includes an electronic control unit functionally connected to the fluid source component to control the delivery of the perceptible message. The control is independent from the operation of the article of PPE. In some embodiments, delivering the fluid flow includes impinging a perceptible gas flow onto the user's skin. In some embodiments, delivering the fluid flow includes releasing one or more perceptible scents into a breathing zone provided by the PPE.

In another aspect, the present disclosure describes a method of delivering a notification to a user in a work environment. The method includes providing a wearable article of personal protection equipment (PPE) to the user; and attaching a fluid notification device to the wearable article of PPE. The fluid notification device includes a fluid source component to release a fluid flow, a fluid flow channel being configured to direct the fluid flow from the fluid source component to the user to deliver perceptible messages, and an electronic control unit functionally connected to the fluid source component to control the delivery of the perceptible message. The control is independent from the operation of the article of PPE. When receiving a notification instruction, the electronic control unit controls the fluid notification device to: release a fluid flow from the fluid source component; and direct the fluid flow via the fluid flow channel to the user to deliver a perceptible message. In some embodiments, delivering the fluid flow includes impinging a perceptible gas flow onto the user's skin. In some embodiments, delivering the fluid flow includes releasing one or more perceptible scents into a breathing zone provided by the PPE.

Various unexpected results and advantages are obtained in exemplary embodiments of the disclosure. One such advantage of exemplary embodiments of the present disclosure is that new avenues for notifications via effective delivery of perceptible messages are provided. The perceptible messages can be effectively delivered via a controlled gas flow impinged on a worker's skin, a scent delivered to a breathing zone of PPE that the worker wears, or a combination thereof.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a block diagram illustrating an example system in which personal protection equipment (PPE) is utilized within a number of work environments and are managed by a personal protection equipment management system, according to one embodiment.

FIG. 2A is a diagrammatical illustration of a powered air purifying respirator where a fluid notification device is attached, according to one embodiment.

FIG. 2B is a block diagram of a fluid notification device, according to one embodiment.

FIG. 2C illustrates a perspective view of a personal protective headpiece where a fluid notification device is attached, according to one embodiment.

FIG. 2D illustrates a diagrammatical illustration of a face-mounted respirator where a fluid notification device is attached, according to one embodiment.

FIG. 2E is a diagrammatical illustration of a powered air purifying respirator where a fluid notification device is attached, according to another embodiment.

FIG. 3 illustrates a perspective view of a gas flow pulsing mechanism, according to one embodiment.

FIG. 4A is a diagrammatical illustration of a powered air purifying respirator where a fluid notification device is attached to deliver scent message, according to one embodiment.

FIG. 4B illustrates a diagrammatical illustration of a face-mounted respirator where a fluid notification device is attached to deliver scent messages, according to one embodiment.

FIG. 4C illustrates a cross-sectional view of a filter where a fluid notification device is attached to deliver scent message, according to one embodiment.

FIG. 5A illustrates a perspective view of a smell actuator, according to one embodiment.

FIG. 5B illustrates a perspective view of a smell actuator, according to another embodiment.

FIG. 5C illustrates a perspective view of a smell actuator, according to another embodiment.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides notification systems and methods for notifying a user wearing personal protection equipment (PPE) in a work environment when there is any meaningful event (e.g., a safety issue, a supervisor's instruction, etc.) in the work environment.

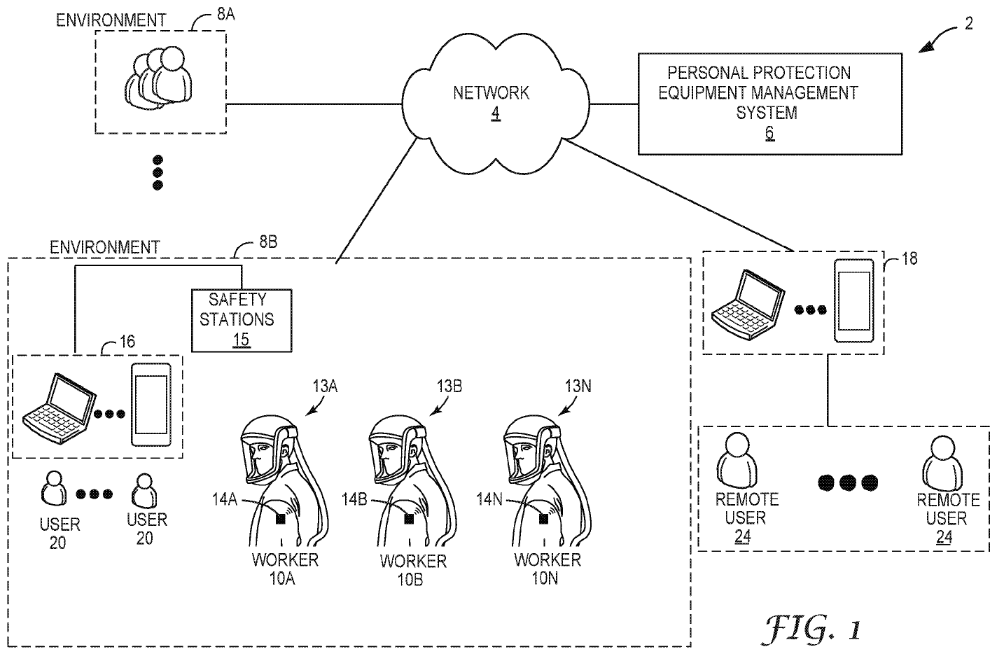

FIG. 1 is a block diagram illustrating an exemplary notification and response management system 2 in which articles of personal protection equipment (PPE) are utilized within a number of work environments and are managed by a personal protection equipment management system (PPEMS) 6, according to some embodiments. Each of physical environment 8A and 8B represents a physical environment, such as a work environment, in which one or more individuals, such as workers 10A-10N, utilize respective personal protection equipment (PPE) 13A-13N while engaging in tasks or activities within the respective environment. Each article of the PPE may include embedded sensors or monitoring devices and processing electronics configured to capture data in real-time as a user (e.g., a worker) engages in activities while wearing the PPE. Each article of the PPE may further include one or more output devices for outputting data that is indicative of operation of the PPE and/or generating and outputting communications to the respective worker 10A-10N. For example, the PPE may include one or more devices to generate audible feedback (e.g., one or more speakers), visual feedback (e.g., one or more displays, light emitting diodes (LEDs) or the like), or tactile feedback (e.g., a device that vibrates or provides other haptic feedback).

Each PPE is configured to communicate data, such as sensed motions, events and conditions, via wireless communications. The PPE 13A-N may, for example, communicate directly with a wireless access point. As another example, each worker 10A-N may be equipped with a respective one of wearable communication hubs 14A-14M that enable and facilitate communication between the PPE 13A-N and PPEMS 6.

Each of environments 8A-B can include computing facilities (e.g., a local area network 4) by which the articles of PPE are able to communicate with PPEMS 6. PPEMS 6 can provide data acquisition, monitoring, activity logging, reporting, predictive analytics, PPE control, alert generation, etc. The environments 8A-B, may also include one or more safety stations 15 distributed throughout the environment to provide viewing stations for accessing additional information related to notifications. In addition, each of environments 8 may include computing facilities that provide an operating environment for end-user computing devices 16, 18 for interacting with PPEMS 6 via network 4. For example, each of environments 8 typically includes one or more safety managers responsible for overseeing safety compliance within the environment. Local users 20 and remote users 24 can interact with PPEMS 6 to control and actively manage many aspects of safely equipment utilized by the workers 10A-B, such as accessing and viewing usage records, analytics and reporting.

In some embodiments, the notification and response management system 2 can provide each PPE one or more notification delivery components/devices for outputting communications to the respective worker 10A-10N. Typical notification delivery components/devices may include, for example, a wearable vibration device or a light emitting device connected to a wearable hub that can alert workers when certain information is to be delivered to the workers. The typical notification delivery means such as audible notification (e.g., a speaker), visual notification (e.g., a LED), or tactile notification (e.g., vibration) may have their respective limitations. For example, the work environment may reduce the reception of notifications/alarms sent through these channels when workers are engaged with vibrating machinery, visual notifications are out of their field of focus, or auditory notifications are not heard due to loud work environment and/or hearing protection.

This disclosure describes new avenues for notifications via effective delivery of perceptible messages. The perceptible messages described herein can include, for example, a controlled gas flow impinged on a worker's skin, a scent delivered to a breathing zone of PPE that the worker wears, etc.

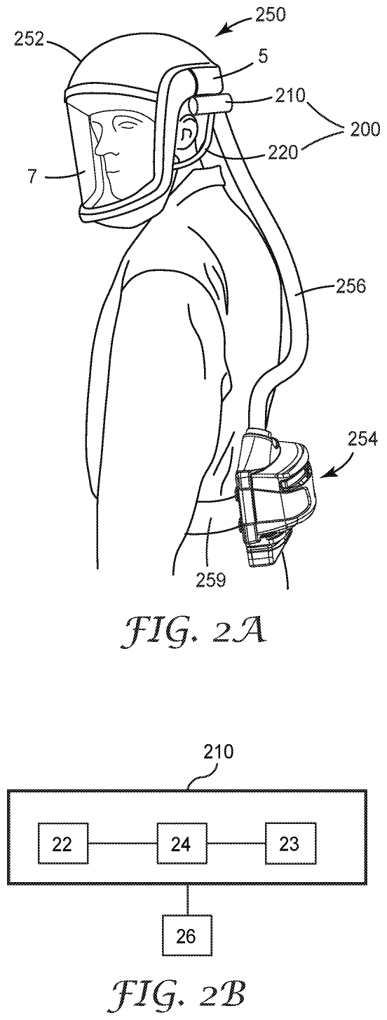

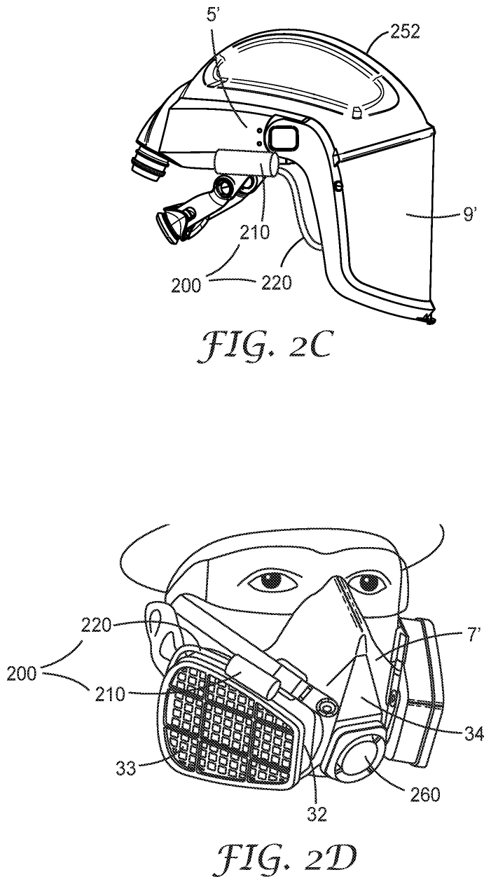

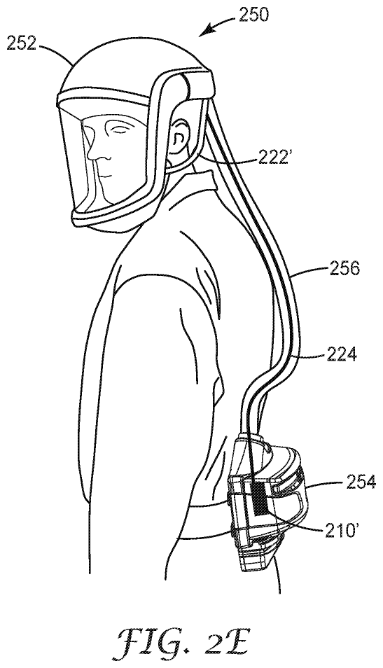

FIG. 2A is a diagrammatical illustration of a powered air purifying respirator (PAPR) where a fluid notification device 200 is attached, according to one embodiment. The PAPR 250 includes a headpiece 252, an air filtration device 254, a breathing tube 256, and a belt 259. The headpiece 252 is worn on the user's head. It at least partially encloses the user's head to form a breathing zone 7, that is, the area around the user's nose and mouth, so that the filtered air is directed to the breathing zone 7. The air filtration device 254 is attached to the belt 259 to enable it to be secured about the user's body. The air filtration device 254 may include a turbo unit and a filter. The turbo unit may house a blower system (not shown), which draws ambient air through the PAPR system using a fan (not shown). Filtered air is supplied to the breathing zone 7 of the headpiece 252 through the breathing tube 256 which is connected between an outlet of the air filtration device 254 and an inlet of the headpiece 252. In some embodiments, the PAPR 250 can include a positive-pressure respirator that does the work of pushing air to the headpiece 252. The air can be powered-air using a battery-powered blower or pull air through a filter, or supplied-air, bringing clean air through a hose from a source outside of the work environment which may be contaminated.

The fluid notification device 200 is attached to the headpiece 252 to deliver perceptible gas flow toward the ear area of the user. It is to be understood that the perceptible gas flow can be impinged on other skin locations such as, for example, a skin area below eyes, a location adjacent a nose, a lip, etc. The fluid notification device 200 includes a gas source component 210 and a tube 220. The gas source component 210 is attached to a side frame 5 of headpiece 252. The tube 220 has an inlet fluidly connected to the gas source component 210, and an outlet pointing towards the ear area of the user, as shown in FIG. 2A. It is to be understood that the tube 220 can be configured to direct gas flow toward any surface skin locations around the user's head, depending on the desired application.

In some embodiments, one or more mechanical components can be provided to the tube 220 to control the gas flow to be delivered to the user's skin. For example, in one embodiment, a baffle can be placed in the tube 220 to mechanically introduce turbulence into the flow, which can vary the gas flow by spraying it across the skin of the recipient. In one embodiment, a rotatable component can be positioned at an orifice adjacent to the outlet of the tube 220, which can rotate upon a gas pressure and point at an angle to the direction of the tube to adjust the exit gas flow.

FIG. 2B illustrates a block diagram of the gas source component 210. In the depicted embodiment of FIG. 2B, the gas source component 210 includes a gas container 22, a gas release mechanism 24 to release gas from the gas container 22 to the tube 220, and an optional blower 23 to blow the released gas into the tube. The fluid notification device 200 further includes an electronic control unit 26 that is functionally connected to the gas source component 210 to control its operation. For example, the electronic control unit 26 can send a control signal to the gas release mechanism 24 to control the release of gas flow from the gas source component 210 into the tube 220.

In some embodiments, the gas container 22 can be a gas tank containing, for example, compressed air. In some embodiments, the gas tank can be dispatchable and refilled. In some embodiments, the gas release mechanism 24 can include, for example, an actuator and a gas valve to control the gas flow from the gas tank to the tube 220. In some embodiments, the gas valve may include a flexible flap that dynamically opens in response to a gas flow. In some embodiments, the gas valve may be a gas metering valve that can meter the volume of gas flow. In some embodiments, the optional blower 23 may include a motor and a fan to blow the released gas to flow into the tube 220. In some embodiments, the electronic control unit 26 can include a microprocessor device, such as, for example, a single chip microcontroller, programmed for executing instructions received from a remote controller to control the operation of gas source component 210. For example, the electronic control unit 26 can send a control signal to an actuator of the gas release mechanism 24 to open/close the gas valve.

In some embodiments, the gas source component 210 may have a configuration of a metered-dose inhaler where an actuator (e.g., an electromechanical actuator) can be provided to activate a gas-containing canister to release a fixed amount of gas upon one activation. It is to be understood that the gas source component 210 can be configured in various forms for releasing gas from a pressurized gas container.

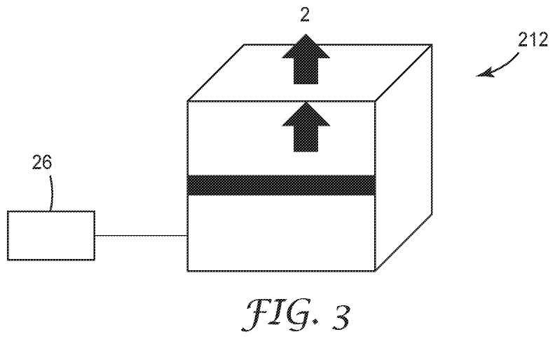

The electronic control unit 26 can control the release of gas from the gas source component 210 in various modes to deliver different perceptible messages. In some embodiments, the gas flow can be controlled to impinge on the user's skin as a single pulse. The duration of the pulse can be controlled, for example, via the gas release mechanism 24. The duration can may be controlled by adjusting by any suitable mechanisms such as, for example, adjusting the diameter of an exit orifice of the tube 20, etc. In some embodiments, the gas flow can be controlled to impinge on the user's skin as multiple pulses. In some embodiments, multiple gas containers can be provided which can be activated in succession to deliver multiple pulses. FIG. 3 illustrates a perspective view of a gas flow pulsing mechanism, according to one embodiment. The electronic control unit 26 sends a control signal to a motor 212 such that the motor 212 ramps up and down for delivering a burst of gas 2.

In some embodiments, the gas flow from the tube 220 can be controlled, via the electronic control unit 26, the gas release mechanism 24, and the optional blower 23 to impinge on the user's skin at a predetermined flow change rate. The various flow change rates may correspond to the respective messages to be delivered to the user. The flow change rate can be adjusted by, for example, ramping up/down a motor, turning on/off the motor, running the motor on an oscillating mode, providing motors at different locations, etc.

In some embodiments, the electronic control unit 26 may receive wireless signals from a remote computing device such as, for example, the computing devices 16, 18 of FIG. 1 related to notification instructions. The electronic control unit 26 can then send control signals to the gas release mechanism 24 to release gas from the gas container 22 to the tube 220, and to the optional blower 23 to control the gas flow. In some embodiments, the notification instructions can be input by a user, such as the users 20 and the remote users 24 of FIG. 1, into the computing devices. In some embodiments, the notification instructions can be automatically generated by the PPEMS 6 of FIG. 1, and delivered to the electronic control unit 26 of the fluid notification device 200.

In some embodiments, the electronic control unit 26 can control the fluid notification device 200 to provide notifications that are driven by perceptible changes in air flow. Changes in airflow may include, for example, air flow speed, flow speed pulsing, air flow direction, air flow source location, air flow temperature, any combinations thereof, etc.

It is to be understood that in some preferred embodiments, the fluid notification device 200 can be controlled independently of the PAPR 250. That is, the operation of the PAPR 250, e.g., delivering filtered air to the breathing zone 7, may not be interrupted by the fluid notification device 200.

The fluid notification device 200 can be provided to any suitable articles of PPE besides the PAPR 250 of FIG. 2A. The articles of PPE may include, for example, a powered air purifying respirator (PAPR), a self-contained breathing apparatus, a fall protection harness, an ear muff, a face shield, a welding mask, etc. FIG. 2C illustrates a perspective view of a personal protective headpiece 252′ where the fluid notification device 200 is attached, according to one embodiment. FIG. 2D illustrates a diagrammatical illustration of a face-mounted respirator 260 where the fluid notification device 200 is attached, according to one embodiment.

In the embodiment of FIG. 2C, the gas source component 210 of the fluid notification device 200 is attached to a side frame 5′ of the personal protective headpiece 252′. The tube 220 extends toward a user's face protected by a face shield 9′ to direct a gas flow onto the user's skin.

In the embodiment of FIG. 2D, the gas source component 210 of the fluid notification device 200 is attached to a filter cartridge 32 of the face-mounted respirator 260. The tube 220 extends toward a user's ear area to direct a gas flow thereon. The filter cartridge 32 includes a housing into which a filter element is contained. A housing cover or grid 33 is provided on the front face of the filter cartridge 32 to protect the filter element. The filter cartridge 32 is attached to a mask body 34 which covers the user's face to form a breathing zone 7′, that is, the area around the user's nose and mouth, so that the filtered air is directed to the breathing zone 7′. The respirator 260 may further include an exhalation valve to allow exhaled air to be rapidly exhausted from the breathing zone 7′ during an exhalation. The fluid notification device 200 is attached to the respirator 260 without affecting the respirator's operation.

In some embodiments, a fluid notification device may not include a separate gas container such as the gas container 22 of the fluid notification device 210 in FIG. 2A. Instead, a gas source component of the fluid notification device can utilize other available gas sources. In some embodiments, a fluid notification device may utilize a gas source from an article of PPE. FIG. 2E is a diagrammatical illustration of the PAPR 250 of FIG. 2A, where a fluid notification device has its gas source component 210′ positioned inside an air filtration device 254, according to another embodiment. The gas source component 210′ may not include a gas container such as the gas container 22 of FIG. 2A. Instead, the gas source component 210′ can divert a small amount of air from the air filtration device 254, and direct the air flow to a tube 222′ via a hose 224′. The hose 224′ is attached to the breathing tube 256 of the PAPR 250. It is to be understood that the diverging air from the air filtration device 254 would not interfere the normal functioning of the PAPR 250. The airflow changes in such a small amount that would not impair basic functionality of the PAPR 250: deliver sufficient, high quality breathing air to the breathing zone 7.

In some embodiments, a fluid notification device can deliver perceptible messages to a user by releasing a scent to a breathing zone of a PPE that the user wears. In the present disclosure, smell can be utilized as a channel to communicate with workers to deliver notifications. In general, humans detect odorants with olfactory receptors in the nose. Unlike most other senses, smell is not relayed through the thalamus, but is transmitted from olfactory receptors via the olfactory bulb directly to the cortex. Smell signals reach the limbic system. Emotions and memories can be easily triggered by smells. Some fluid notification devices described herein can provide scent driven olfactory notifications, which are less likely to be ignored by workers as compared to visual notifications.

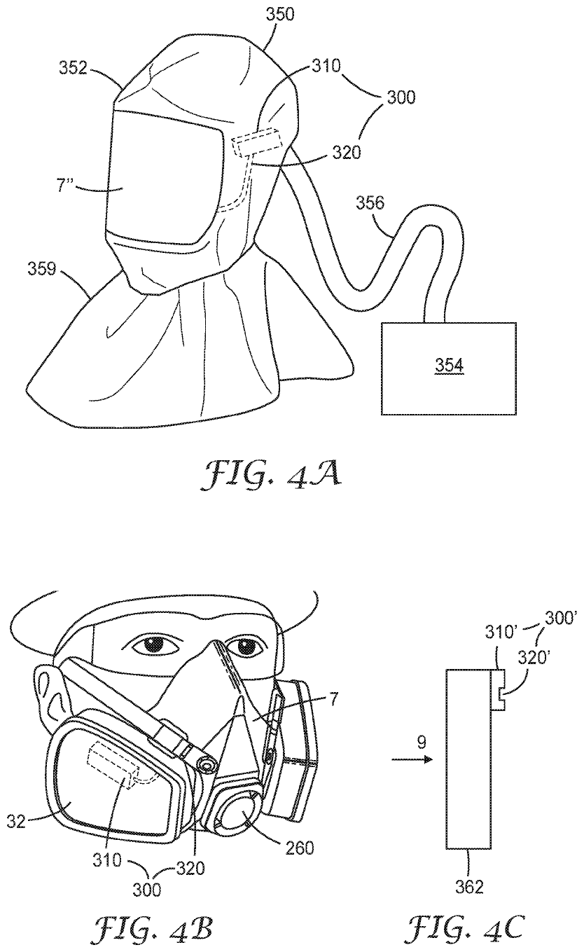

FIG. 4A is a diagrammatical illustration of a powered air purifying respirator (PAPR) 350 where a fluid notification device 300 is attached to deliver scent messages, according to one embodiment. The PAPR 350 includes a headpiece 352, an air filtration device 354, a breathing tube 356, and a shroud 359 connected to the headpiece 352. The headpiece 352 is worn on the user's head. The headpiece 352 and the shroud 359 at least partially encloses the user's head, shoulder, neck and chest to form a breathing zone 7″, that is, the area around the user's nose and mouth, so that the filtered air is directed from the filtration device 354 via the breathing tube 356 to the breathing zone 7″.

The fluid notification device 300 is attached to the headpiece 352 to deliver one or more scents into the breathing zone 7″. The fluid notification device 300 includes a scent source component 310 and a tube 320. The scent source component 310 is attached to the headpiece 252. The tube 320 has an inlet fluidly connected to the scent source component 310, and an outlet pointing into the breathing zone 7″. In the depicted embodiment of FIG. 4A, the scent source component 310 and the tube 320 are positioned inside the headpiece. It is to be understood that the scent source component 310 and the tube 320 can be at least partially positioned outside of the headpiece 350 as long as the outlet of the tube 320 is in fluid communication with the breathing zone 7″. The fluid notification device 300 further includes an electronic control unit (not shown) functionally connected to the scent source component 310 to control the release of the scents to deliver the perceptible message. In some embodiments, the fluid notification device 300 may further include a gas source component such as, for example, the gas source component 210 of FIGS. 2A-D, to release a gas flow to carry the released scents into the breathing zone of the PPE.

The fluid notification device 300 can be provided to any suitable articles of PPE that provide a breathing zone, besides the PAPR 350 of FIG. 4A. The articles of PPE may include, for example, a powered air purifying respirator (PAPR), a self-contained breathing apparatus, a fall protection harness, a face shield, a welding mask, etc. FIG. 4B is a diagrammatical illustration of the face-mounted respirator 260 of FIG. 2D, where the fluid notification device 300 is attached to deliver scent messages, according to one embodiment.

In the embodiment of FIG. 4B, the scent source component 310 of the fluid notification device 300 is built into the filter cartridge 32 of the face-mounted respirator 260. The tube 320 extends into a breathing zone 7 defined by a mask body of the respirator 260. In the depicted embodiment of FIG. 4B, the fluid notification device 300 is attached to an inner side of the filter cartridge 32, with the tube 320 having its outlet in fluid communication with the breathing zone 7′ to deliver one or more scents into the user's nose. In some embodiments, the scent source component 310 and the tube 320 can be attached to an inside face of a filter received by the filter cartridge 32 or positioned inside the breathing zone 7′.

In some embodiments, a fluid notification device may not include a separate tube to direct scent to a breathing zone of PPE. Instead, the fluid notification device may include a scent source component which has an opening to release scent therefrom. FIG. 4C illustrates a cross-sectional view of a filter 362 where a fluid notification device 300′ is attached to deliver scent messages, according to one embodiment. The filter 362 can be received in the filtered cartridge 32 of FIG. 4B. The fluid notification device 300′ includes a scent source component 310′ attached to a downstream side of the filter 362. The scent source component 310′ includes an opening 320′ to release one or more scents. The air 9 can be filtered by the filter 362 and carry the scents released from the scent source component 310′ into the breathing zone 7′ of FIG. 4B to deliver scent messages to the user.

In some embodiments, a fluid notification device described herein (e.g., 300 of FIGS. 4A-B, 300′ of FIG. 4C) may further include an electronic control unit functionally connected to a scent source component thereof to control the delivery of scent messages to a user wearing the PPE in a work environment. The electronic control unit may receive wireless signals from a remote computing device such as, for example, the computing devices 16, 18 of FIG. 1 related to notification instructions. The electronic control unit can then send control signals to the scent source component to release one or more scents into the breathing zone of the PPE. In some embodiments, the notification instructions can be input by a user, such as the users 20 and the remote users 24 of FIG. 1, into the computing devices. In some embodiments, the notification instructions can be automatically generated by the PPEMS 6 of FIG. 1, and delivered to the electronic control unit of the fluid notification device 300 or 300′.

It is to be understood that in some preferred embodiments, the fluid notification device 300 or 300′ can be controlled independently of the PAPR 250. That is, the operation of the PAPR 350, e.g., delivering filtered air to the breathing zone 7, may not be interrupted by the attached fluid notification device.

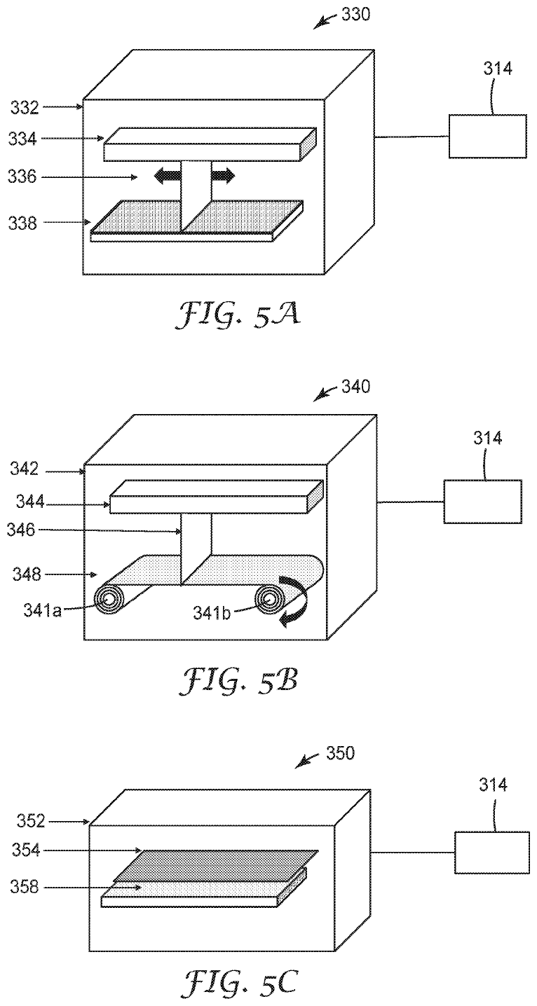

A scent source component of a fluid notification device described herein (e.g., 310 of FIGS. 4A-B, 310′ of FIG. 4C) can include various scent generators to generate one or more scents. FIGS. 5A-B illustrates exemplary embodiments of a scent generator. In the embodiment of FIG. 5A, a scent generator 330 includes a smell actuation box 332. A scent strip 338 is fixed inside the box 332. The scent strip 338 includes a solid base layer and an array of scent capsules attached to the solid base layer. A scratcher 336, when moved by a scratcher actuator 334 relative to the scent strip 338, can scratch the scent strip surface and break the scent capsules to release scent. An electronic control unit 314 is provided to functionally connect to the scratcher actuator 334 to control its movement. In the embodiment of FIG. 5B, a scent generator 340 includes a smell actuation box 342. A scent strip 348 is provided inside the box 332, wrapping around rollers 341a and 341b. The scent strip 348 includes a solid base layer and an array of scent capsules attached to the solid base layer. A scratcher 346 is anchored by an anchor 344. When the scent strip 348 is moved by rotating, via a motor, the rollers 341a and 341b relative to the scratcher 346, the scratcher 346 can scratch the scent strip surface and break the scent capsules to release scent. An electronic control unit 314 is provided to functionally connect to the motor to control the rotation of the rollers 341a and 341b. In the embodiment of FIG. 5C, a scent generator 350 includes a smell actuation box 352. A scent source 358 is provided inside the box 352. A smell barrier 354 is provided to contain/release or open/close the scent source 358. In the depicted embodiment, the smell barrier 354 includes a flap that opens upon a pressure change or a mechanical activation by an actuator. An electronic control unit 314 can be provided to functionally connect to the actuator to control the status (open/close) of the smell barrier 354. In some embodiments, the scents released from the scent source components can carried by a gas flow from a gas source component such as for example, the gas source component 210 of FIGS. 2A-D, into a breathing zone of the PPE that the worker wears.

In some embodiments, the fluid notification device 300 or 300′ can deliver one or more scents that have a smell associated with its intended meaning. A user can be trained to differentiate between the smell notifications with distinct meanings (e.g., low urgency events, medium urgency events, etc.).

In some embodiments, smell notifications can be used in conjunction with other types of notifications such as, for example, a gas flow notification provided by the fluid notification device 200, an audible notification (e.g., provided by a speaker), a visual notification (e.g., provided by a LED), a tactile notification (e.g., provided by a vibration device), etc.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### LISTING OF EXEMPLARY EMBODIMENTS

Exemplary embodiments are listed below. It is to be understood that any one of embodiments 1-18 and 19-23 can be combined.

Embodiment 1 is a notification system comprising:

at least one wearable article of personal protection equipment (PPE) to be worn by a user; and

a fluid notification device attached to the wearable article of PPE,

wherein the fluid notification device comprises a fluid source component to release a fluid flow and a fluid flow channel being configured to direct the fluid flow from the fluid source component to the user to deliver perceptible message, and
wherein the fluid notification device further comprises an electronic control unit functionally connected to the fluid source component to control the delivery of the perceptible message, the control being independent from the operation of the article of PPE.
   Embodiment 2 is the notification system of embodiment 1, wherein the fluid source component comprises a gas container, and a gas release mechanism to release gas from the gas container to the fluid flow channel.
   Embodiment 3 is the notification system of embodiment 2, wherein the fluid source component further comprises a blower system to blow the released gas into the fluid flow channel.
   Embodiment 4 is the notification system of embodiment 2 or 3, wherein the fluid flow channel extends to point to a skin surface of the user to direct the released gas to the skin surface.
   Embodiment 5 is the notification system of embodiment 4, wherein the released gas is directed to an ear area of the user.
   Embodiment 6 is the notification system of any one of embodiments 2-5, wherein the gas release mechanism further comprises a gas flow actuator.
   Embodiment 7 is the notification system of any one of embodiments 1-6, wherein the fluid source component further comprises a scent generator fluidly connected to the fluid flow channel to generate one or more scents into the fluid flow channel.
   Embodiment 8 is the notification system of embodiment 7, wherein the fluid flow channel extends into a breathing zone of the article of PPE to direct the generated scents from the scent generator into the breathing zone.
   Embodiment 9 is the notification system of embodiment 7 or 8, wherein the smell generator comprises a strip of scent capsules configured to emit the scents upon friction.
   Embodiment 10 is the notification system of embodiment 9, wherein the smell generator further comprises an actuator to move at least one of a scratcher and the strip of scent capsules to scratch the strip of scent capsules.
   Embodiment 11 is the notification system of embodiment 9 or 10, wherein the smell generator further comprises a smell barrier to control the delivery of the scents from the strip into the fluid flow channel.
   Embodiment 12 is the notification system of any one of embodiments 1-10, wherein the article of PPE comprises a powered air purifying respirator (PAPR).
   Embodiment 13 is the notification system of embodiment 12, wherein the fluid source component of the fluid notification device is attached to a headpiece of the PAPR.
   Embodiment 14 is the notification system of embodiment 12 or 13, wherein the fluid source component of the fluid notification device is at least partially disposed inside an air filtration device of the PAPR to divert a gas flow from the air filtration device.
   Embodiment 15 is the notification system of any one of embodiments 1-14, wherein the article of PPE comprises a headpiece.
   Embodiment 16 is the notification system of any one of embodiments 1-15, wherein the article of PPE comprises a face-mounted respirator.
   Embodiment 17 is the notification system of any one of embodiments 1-16, further comprises a remote computing device comprising:

one or more computer processors; and

a memory comprising instructions that when executed by the one or more computer processors cause the one or more computer processors to:
receive notification instructions; and
in response to receiving the notification instructions, communicate to the electronic control unit to activate the fluid notification device to deliver the perceptible message to the user.
   Embodiment 18 is the notification system of embodiment 17, wherein the one or more computer processors, in response to receiving the notification instructions, communicate to the electronic control unit to control the fluid source component.
   Embodiment 19 is a method of delivering a notification to a user in a work environment, the method comprising:

providing a wearable article of personal protection equipment (PPE) to the user;

attaching a fluid notification device to the wearable article of PPE, the fluid notification device comprising a fluid source component to release a fluid flow, a fluid flow channel being configured to direct the fluid flow from the fluid source component to the user to deliver perceptible messages, and an electronic control unit functionally connected to the fluid source component to control the delivery of the perceptible message, the control being independent from the operation of the article of PPE;

when receiving a notification instruction, the electronic control unit controls the fluid notification device to:

release a fluid flow from the fluid source component; and

direct the fluid flow via the fluid flow channel to the user to deliver a perceptible message.

Embodiment 20 is the method of embodiment 19, wherein directing the fluid flow comprises impinging a gas flow onto the user's skin.
Embodiment 21 is the method of embodiment 20, further comprising providing a perceptible change to the gas flow, including one or more changes of gas flow speed, gas flow pulsing, and gas flow direction, the perceptible change being associated with the perceptible message.
Embodiment 22 is the method of any one of embodiments 19-21, wherein releasing the fluid flow comprises releasing one or more scents.
Embodiment 23 is the method of embodiment 22, wherein directing the fluid flow comprises directing the scents into a breathing zone of the PPE.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, various exemplary embodiments have been described. These and other embodiments are within the scope of the following claims.

1. A notification system comprising:
at least one wearable article of personal protection equipment (PPE) to be worn by a user; and
a fluid notification device attached to the wearable article of PPE,
wherein the fluid notification device comprises a fluid source component to release a fluid flow and a fluid flow channel being configured to direct the fluid flow from the fluid source component to the user to deliver perceptible message, and
wherein the fluid notification device further comprises an electronic control unit functionally connected to the fluid source component to control the delivery of the perceptible message, the control being independent from the operation of the article of PPE.

2. The notification system of claim 1, wherein the fluid source component comprises a gas container, and a gas release mechanism to release gas from the gas container to the fluid flow channel.

3. The notification system of claim 2, wherein the fluid source component further comprises a blower system to blow the released gas into the fluid flow channel.

4. The notification system of claim 2, wherein the fluid flow channel extends to point to a skin surface of the user to direct the released gas to the skin surface.

5. The notification system of claim 4, wherein the released gas is directed to an ear area of the user.

6. The notification system of claim 2, wherein the gas release mechanism further comprises a gas flow actuator.

7. The notification system of claim 1, wherein the fluid source component further comprises a scent generator fluidly connected to the fluid flow channel to generate one or more scents into the fluid flow channel.

8. The notification system of claim 7, wherein the fluid flow channel extends into a breathing zone of the article of PPE to direct the generated scents from the scent generator into the breathing zone.

9. The notification system of claim 7, wherein the smell generator comprises a strip of scent capsules configured to emit the scents upon friction.

10. The notification system of claim 9, wherein the smell generator further comprises an actuator to move at least one of a scratcher and the strip of scent capsules to scratch the strip of scent capsules.

11. The notification system of claim 9, wherein the smell generator further comprises a smell barrier to control the delivery of the scents from the strip into the fluid flow channel.

12. The notification system of claim 1, wherein the article of PPE comprises a powered air purifying respirator (PAPR).

13. The notification system of claim 12, wherein the fluid source component of the fluid notification device is attached to a headpiece of the PAPR.

14. The notification system of claim 12, wherein the fluid source component of the fluid notification device is at least partially disposed inside an air filtration device of the PAPR to divert a gas flow from the air filtration device.

15. The notification system of claim 1, wherein the article of PPE comprises a headpiece.

16-18. (canceled)

19. A method of delivering a notification to a user in a work environment, the method comprising:
providing a wearable article of personal protection equipment (PPE) to the user;
attaching a fluid notification device to the wearable article of PPE, the fluid notification device comprising a fluid source component to release a fluid flow, a fluid flow channel being configured to direct the fluid flow from the fluid source component to the user to deliver perceptible messages, and an electronic control unit functionally connected to the fluid source component to control the delivery of the perceptible message, the control being independent from the operation of the article of PPE;
when receiving a notification instruction, the electronic control unit controls the fluid notification device to:
release a fluid flow from the fluid source component; and
direct the fluid flow via the fluid flow channel to the user to deliver a perceptible message.

20. The method of claim 19, wherein directing the fluid flow comprises impinging a gas flow onto the user's skin.

21. The method of claim 20, further comprising providing a perceptible change to the gas flow, the perceptible change being associated with the perceptible message.

22. The method of claim 19, wherein releasing the fluid flow comprises releasing one or more scents.

23. The method of claim 22, wherein directing the fluid flow comprises directing the scents into a breathing zone of the PPE.
